(19) United States
(12) Patent Application Publication
(10) Pub. No.: US 2026/0172336 A1
(43) Pub. Date: Jun. 18, 2026

(54) Packet Latency Computation and Drop Detection

(71) Applicant: Arista Networks, Inc., Santa Clara, CA (US)

(72) Inventors: Kenneth H. CHIANG, Fremont, CA (US); Sean DAO, Gardena, CA (US); Sandip SHAH, Fremont, CA (US); Michael T. STOLARCHUK, Ypsilanti, MI (US); Ryan IZARD, Seneca, SC (US); Harry DHILLON, Delta (CA); Robert LING, San Jose, CA (US)

(21) Appl. No.: 18/978,323

(22) Filed: Dec. 12, 2024

(51) Int. Cl. H04L 43/106; H04L 43/0864

(52) U.S. Cl. CPC H04L 43/106; H04L 43/0864

(57) ABSTRACT

Traffic in a production network is tapped (monitored) at various tap points between network devices in the production network and sent to service nodes in a monitoring fabric. Traffic monitored at each tap point is copied or otherwise mirrored to a corresponding interface (ingress point) at the edge of the monitoring fabric. In the monitoring fabric, packets received at an ingress point are timestamped and streamed to service nodes. Each packet stream corresponds to a tap point in the production network. A service node computes the latencies of packet instances between tap points in the production network based on timestamps in the packet streams corresponding to those tap points. Dropped packets can be detected when packet instances do not appear at expected tap points, or when latencies between tap points exceed a threshold.

### BACKGROUND

The present disclosure is related to monitoring traffic in a production network to troubleshoot slow network performance in the production network, to certify that the production network is operating according to operational specifications, to ensure there are no latency hot spots in the network, and so on. Traffic in a production network can be monitored by tapping the traffic between network devices. Monitoring technologies include TAP (test access point) techniques, port mirroring (e.g., using SPAN (switch port analyzer) protocol), and so on, where a copy of the monitored traffic can be forwarded for analysis.

The monitored traffic can be provided to a monitoring fabric for storage and analysis. Production network traffic can be monitored at various tap points in the network. The streams of monitored traffic can be provided to edge devices on the monitoring fabric. The edge devices can then forward the packet to various analytical nodes within the monitoring fabric.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a high-level generalized representation of a data network adaptable for the present disclosure.

FIG. 2 shows additional detail in the production network shown in FIG. 1.

FIG. 3 shows additional detail in the monitoring network shown in FIG. 1.

FIG. 4 represents operations in a service node in accordance with the present disclosure.

FIG. 5 represents a packet table in accordance with the present disclosure.

FIG. 6 is an illustrative example of a table entry in the packet table of the present disclosure.

FIG. 7 is a computer system in accordance with the present disclosure.

### DETAILED DESCRIPTION

The present disclosure is related to monitoring traffic in a production network to troubleshoot slow network performance in the production network, to certify that the production network is operating as expected, to ensure there are no latency hot spots in the network, and so on. The traffic is monitored to identify network devices that may be causing delays or are dropping packets. Generally, traffic in the production network is tapped (sampled, monitored) at various tap points between network devices in the production network and sent to service nodes in a monitoring fabric. Traffic monitored at each tap point is copied or otherwise mirrored to a corresponding interface (ingress point) at the edge of the monitoring fabric. In the monitoring fabric, packets received at an ingress point are timestamped and streamed to service nodes. Each packet stream corresponds to a tap point in the production network.

In accordance with the present disclosure, a user specifies a mapping between tap points in the production network and ingress points at the edge of the monitoring fabric. An ingress point is an interface on an edge device of the monitoring fabric. Because traffic through a tap point can be bidirectional, a tap point may be mapped to two ingress points. The user also defines the monitoring topology by specifying which packet streams, and hence which tap points, go to which service nodes. A user can thus track the end-to-end traversal of packets between a source node and a destination node in the production network by assigning packet streams to a service node that correspond to tap points along the path.

A service node computes the latency of packet instances between tap points in the production network based on timestamps in the packet streams corresponding to those tap points. Dropped packets can be detected when an instance of a packet does not appear at an expected tap point, or when the latency between tap points exceeds a threshold. Forwarding errors (e.g., resulting from user error, exchange of corrupted routing information, etc.) can be detected when a service node sees packet streams from a tap point that is not expected in a path between a source and destination.

In some embodiments, a service node identifies each packet instance in the received packet streams, for example, by computing a hash value on the contents of the packet (noting that certain fields such as TTL and checksum are masked out). In this way, occurrences of the same packet (packet instance) from different packet streams can be identified by virtue of having the same hash value. The service node collects the hash values in a table, where each table entry corresponds to a hashed packet and is keyed by the hash value. The table entry for a hashed packet comprises a 5-tuple attribute of the flow (e.g., source/destination IP addresses, source/destination ports, and protocol type) and a 2-tuple for each packet stream that the packet appears in. Each 2-tuple comprises the data pair <ingress point, timestamp>, where ingress point identifies the packet stream (and in turn the tap point in the production network), and the timestamp serves as an indication of when the packet was tapped. In some embodiments, for example, the packet is timestamped at the time the packet arrives at the ingress point on the monitoring fabric, and so the timestamp is an indirect indication of when the packet was tapped.

The service node can periodically process the ingress point/timestamp data collected in the table to compute latencies (delays) between tap points for each packet instance. A dropped packet is detected when the latency between two tap points exceeds a threshold, or when the packet instance is not seen at an expected tap point.

The computed latencies, detected packet drops, and other metrics can be sent to a collector for further analysis.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

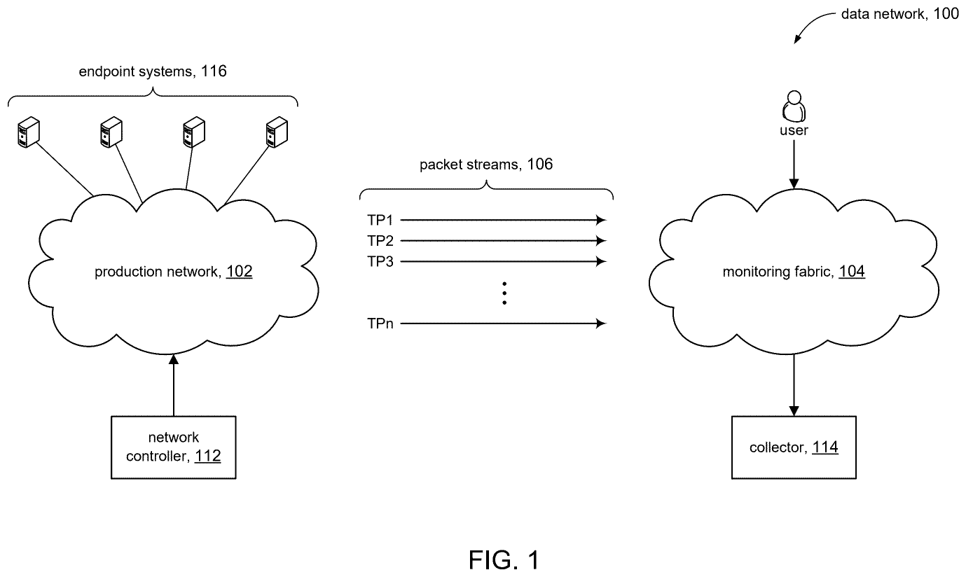

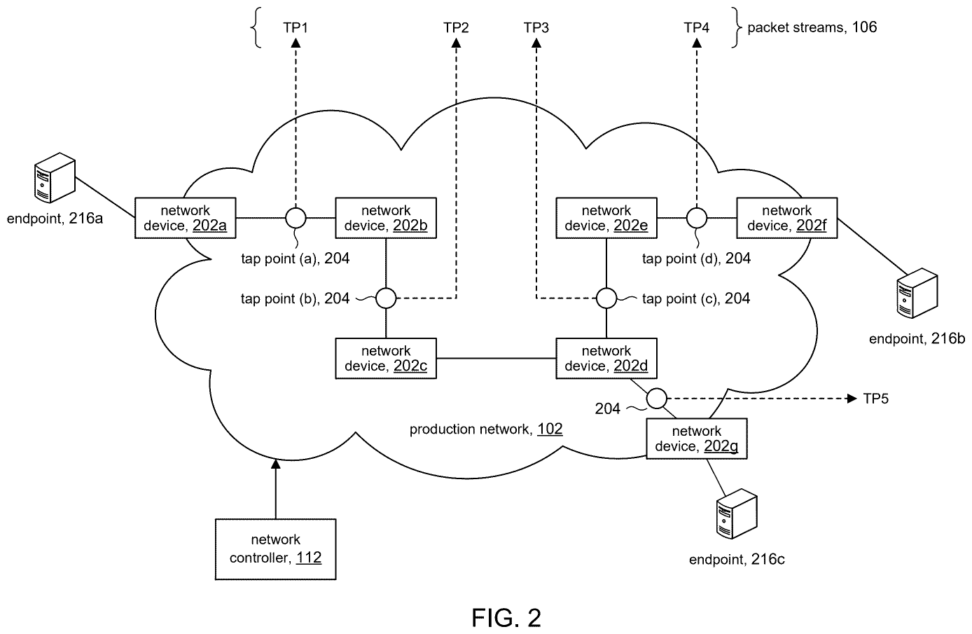

FIG. 1 is a high-level representation of a data network that can embody the techniques in accordance with the present disclosure. Data network 100 includes production network 102 (the customer's network) to provide communication between endpoint computer systems 116 such as servers and the customer's users. Packet streams 106 from tap points (204, FIG. 2) deployed in production network 102 are transmitted from the production network to monitoring fabric 104 to monitor traffic flow in the production network in accordance with the present disclosure.

Network devices (202, FIG. 2) that constitute production network 102 can be configured and otherwise managed by network controller 112. In some embodiments, network controller 112 can configure the tap points in production network 102 to mirror/sample traffic flows between network devices in the production network to generate corresponding packet streams 106. An example of a network controller is the CloudVision® network management platform developed and sold/licensed by Arista Networks, Inc. of Santa Clara, California; although it will be understood that embodiments in accordance with the present disclosure can be used with other controllers.

Monitoring fabric 104 can receive packet streams 106 to compute metrics using the packet streams in accordance with the present disclosure. The computed metrics can be provided to collector 114 for later analysis. An example of a monitoring fabric is the DMF™ (DANZ Monitoring Fabric) network packet broker, developed and sold/licensed by Arista Networks, Inc. of Santa Clara, California. It will be understood that any suitable monitoring fabric can be used.

FIG. 2 illustrates additional details of production network 102 in accordance with some embodiments. Production network 102 comprises network devices such as network devices 202a, 202b, 202c, 202d, 202e, 202f. Network devices 202a, 202f (also referred to as edge devices) serve as interfaces between external systems (e.g., endpoints 216a, 216b, 216c, collectively 216) and production network 102.

FIG. 2 illustrates an example of a “path” as used herein. A path refers to the set of hops between endpoints. In FIG. 2, for example, the path between endpoints 216a and 216b comprises network devices 202a-202f. The path between endpoints 216c and 216b comprises network devices 202g, 202d, 202e, 202f, and likewise for other endpoints in production network 102. In some instances, endpoints may have multiple paths defined between them; for example, multicast traffic, ECMP, etc. For discussion purposes, embodiments will assume without loss of generality a path as being the set of hops between two (source and destination) endpoints.

Tap points 204 can be provided/configured along the path between a source endpoint and a destination endpoint. Tap points 204 generate packet streams 106 by sampling the traffic (packets) that flow between hops (network devices). For example, packet stream TP1 comprises packets from traffic flowing between network devices 202a and 202b, packet stream TP2 comprises packets in the traffic between network devices 202b and 202c, and so on. Tap points 204 can be implemented in the hops themselves or by external devices connected between hops.

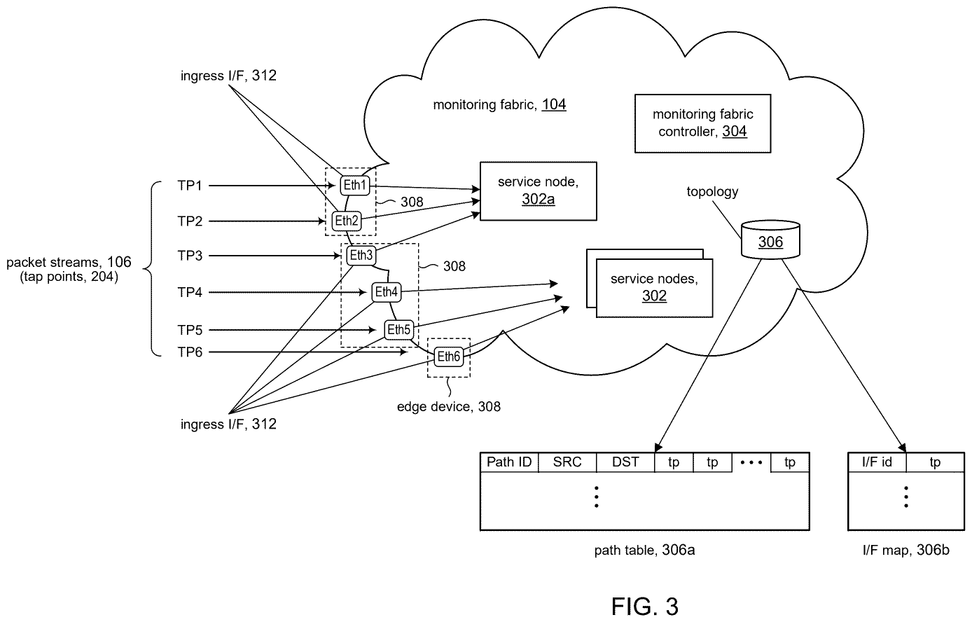

FIG. 3 is a high level diagram that represents details of monitoring fabric 104 in accordance with some embodiments. Monitoring fabric 104 comprises service nodes 302 and a monitoring fabric controller 304. Service nodes 302 receive packet streams 106 from production network 102 which are then processed and analyzed in accordance with the present disclosure.

Each packet stream 106 ingresses on a corresponding ingress interface (I/F) 312 at the edge of monitoring fabric 104. FIG. 3, for example, illustrates packet stream TP1 ingresses on ingress interface Eth1, packet stream TP2 ingresses on ingress interface Eth2, and so on. The assignment of a packet stream 106 to an ingress interface 312 is made by a user, for example, a network administrator of production network 102. Ingress interfaces 312 are interfaces (physical, logical) on edge devices 308 deployed at the edge of monitoring fabric 104.

Monitoring fabric controller 304 can assign packet streams 106 to service nodes 302 for processing. Monitoring fabric controller 304, for example, can program forwarding tables in edge devices 308 to forward traffic, namely packet streams 106, to service nodes 302. For example, FIG. 3 shows that ingress interfaces Eth1, Eth2, and Eth3 are programmed to forward incoming traffic to service node 302a. The incoming traffic will ingress the service node on corresponding interfaces of the service node connected to ingress interfaces Eth1, Eth2, and Eth3.

Monitoring fabric 104 includes topology 306. In some embodiments, topology 306 can be stored in monitoring fabric controller 304, and in other embodiments the topology can be stored in a server (not shown). Topology 306 comprises information that identifies tap points 204 between endpoints 216 in production network 102. The information in topology 306, for example, can include path table 306a and I/F mapping 306b. The topology 306 is generated and managed by the user (e.g., network administrator).

Path table 306a defines the paths in production network 102 that are monitored. Each path is identified by a source endpoint (e.g., its IP address) and a destination endpoint (e.g., its IP address). The path is defined in terms of the tap points between the source and destination endpoints. Referring to FIG. 2, for example, the path between endpoints 216a and 216b comprises tap points TP1, TP2, TP3, and TP4. The path between endpoints 216a and 216c comprises tap points TP1, TP2, and TP5.

Each path is unidirectional, so that between any two endpoints there are two paths, where the source and destination endpoint designations and the list of tap points in one path are reversed in the other path. For example, the path between endpoint 216a as source and endpoint 216b as destination comprises the ordered list of tap points TP1, TP2, TP3, and TP4. Conversely, the path between endpoint 216b as source and endpoint 216a as destination comprises the ordered list of tap points TP4, TP3, TP2, and TP1.

I/F mapping 306b maps ingress interfaces 312 to respective tap points 204 in production network 102. Each entry in I/F mapping 306b comprises the identifier of an ingress interface 312 and the identifier of the tap point 204 in production network 102 that produces the packet stream 106 received on that ingress interface.

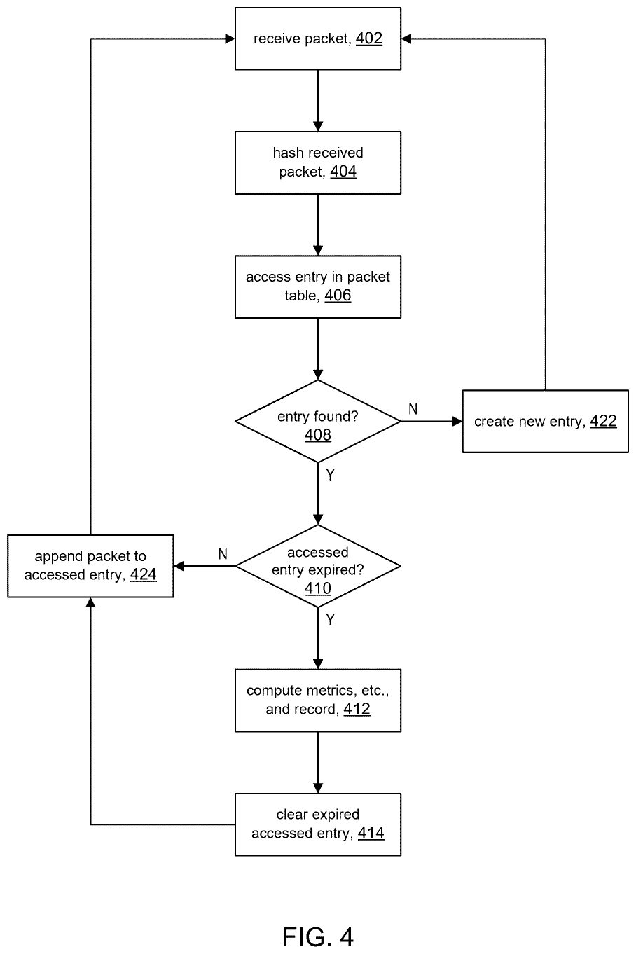

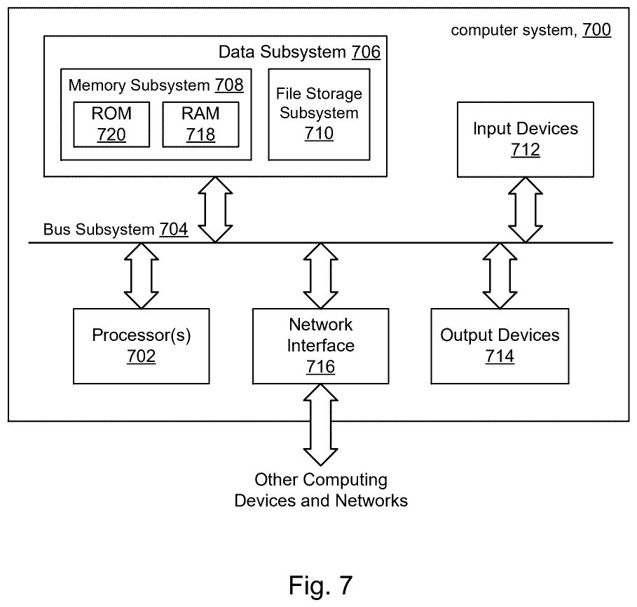

Referring to FIG. 4 the discussion will now turn to a high level description of operations and processing by a service node (e.g., 302a) in monitoring fabric 104 in accordance with the present disclosure. In some embodiments, for example, the service node can include computer executable program code (e.g., stored on a non-transitory computer-readable storage memory device), which when executed by their respective processors (e.g., 702, FIG. 7), can cause the service node to perform processing in accordance with FIG. 4. The operation and processing blocks described below are not necessarily executed in the order shown. Operations can be combined or broken out into smaller operations in various embodiments. Operations can be allocated for execution among one or more concurrently executing processes and/or threads. The flow of operations performed by the processor is not necessarily limited to the order of operations shown. Moreover, operations may be combined or broken out into smaller operations in various embodiments.

At operation 402, the service node can receive a packet on one of its interfaces. The received packet can be tagged or otherwise associated with a timestamp that represents when the packet was received and which correlates to when the packet was sampled in production network 102. In some embodiments for example, the timestamp can be added to the received packet by the edge device (e.g., 308) on the monitoring fabric.

At operation 404, the service node can compute a value that identifies the received packet. A common computation is hashing. The service node can compute a hash value by hashing the data that constitute the received packet. Because the present disclosure tracks each instance of a packet as it travels from one tap point to the next, the computed hash value should uniquely identify each packet instance. An instance of a packet cannot be identified simply by its 5-tuple because all packets in the flow between ports on the source and destination will have the same 5-tuple. An instance of a packet as it traverses from hop to hop can be identified by its payload because it is most likely to be unique from one packet to the next in a given flow. Accordingly, the hash value can be computed by hashing the packet's source and destination IP addresses and all (or at least some portion) of the packet's payload to ensure a unique value and hence uniquely identify the packet instance. Certain parts of the packet may be masked out or otherwise omitted. For example, the TTL (time to live) data field may be masked out because the TTL value will change as the packet goes from one hop to the next. Likewise, the checksum would be masked out because it is computed over the TTL.

At operation 406, the service node can look in a packet table for a table entry corresponding to the received packet. The packet table, for example, can be indexed based on the hash value computed from the received packet.

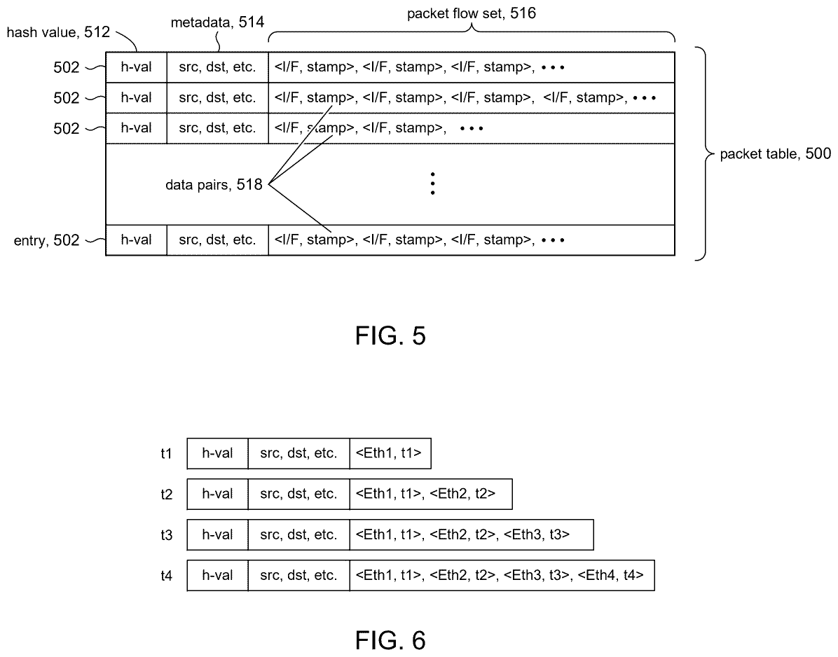

Referring for a moment to FIG. 5, an example embodiment of a packet table 500 comprises table entries 502. Each table entry 502 corresponds to an instance of a packet:
Hash value 512 is the computed hash value of the packet instance.
Metadata 514 can include the IP address of the source endpoint that originated the packet instance and the IP addresses of the destination endpoint of the packet instance. In some embodiments, metadata 514 can comprise a 5-tuple attribute of the flow, for example, source/destination IP addresses, source/destination ports, and protocol type.
Packet flow set 516 is a data object that represents the flow of the packet instance from one tap point 204 to the next on the path from source to destination. Packet flow set 516 comprises a data pair 518 for each tap point 204 in production network 102 that has sampled the packet instance. Each data pair 518 comprises an identifier of the ingress interface 312 that the sampled packet instance ingressed on and a timestamp indicative of its time of ingress. The ingress interface identifier indicates the tap point 204 in the production network 102 that sampled the packet instance; e.g., per I/F map 306b.

At decision point 408, if packet table 500 does not have a table entry for the received packet, then processing can proceed to operation 422 to add the received packet to a new table entry in the packet table. If a table entry for the received packet is found in packet table 500, the table entry is accessed and processing can proceed to decision point 410.

At decision point 410, the service node can determine if the table entry accessed at operation 406 has expired. As a practical matter, the packet flow set data object 516 in a table entry 502 cannot grow indefinitely, and so the table entry can be set to expire in order to clear the packet flow data object. If the accessed table entry for the received packet is deemed not to have expired, then processing can proceed to operation 424 to add a data pair (namely, ingress interface and timestamp) of the received packet to the accessed table entry. If the accessed table entry for the received packet is deemed to have expired, then processing can proceed to operation 412 to process an expired table entry. In accordance with some embodiments, a table entry is deemed to have expired after 200 ms, although it will be appreciated that the expiration time can be any suitable duration and is user configurable. In some embodiments, expiration of a table entry can be based on the timestamp of the earliest sampled packet instance in packet flow set 516 of the accessed table entry.

In some embodiments, the detection and processing of expired entries in packet table 500 can occur separately and independently from the handling of incoming packets. In some embodiments, for example, the service node can run one process to handle incoming packets and a separate and independent process that monitors packet table 500 to determine and handle expired entries.

At operation 412, in response to the accessed table entry having expired, the service node can compute metrics for the packet instance associated with the accessed table entry. Metrics can include latency statistics associated with the packet instance between tap points, such as minimum latency, maximum latency, mean latency, percentiles (e.g., P90, P95, P99), and so on. For purposes of computing latency, a data pair of the received packet can be appended to the accessed expired table entry. The service node can identify packet anomalies such as dropped packets, unexpected packets, and so on. The computed metrics and any packet anomalies can be recorded and sent to a collector; for example, using IPFIX (IP Flow Information Export) or any other suitable communication protocol. Latency computation and anomaly detection are described in more detail below.

At operation 414, the service node can clear the accessed and expired table entry by deleting the data pairs in the packet flow set data object of the accessed table entry. A data pair of the received packet is added to the packet flow set data object as the first data pair in order to maintain continuity with the cleared data pairs. Accordingly, processing can proceed to operation 424.

At operation 422, the service node can add a new table entry to packet table 500 when the received packet does not already have a corresponding table entry in the packet table (N branch of decision point 408). A new table entry is allocated in packet table 500. The hash value data field 512 in the new table entry is set to the hash value computed for the received packet (operation 404). The metadata data field 514 in the new table entry is set to the 5-tuple flow attribute of the received packet. The packet flow set data object 516 in the new table entry initially contains a single data pair 518, namely the identifier of the ingress interface on which the received packet ingressed and the timestamp representing its time of arrival at the ingress interface. Processing can return to operation 402 to receive and process the next packet.

At operation 424, the service node can append a data pair of the received packet to the accessed table entry in response to the accessed entry being deemed not to have expired (N branch of decision point 410), or when the existing table entry for the received packet has expired (operation 414). The data pair of the received packet comprises information associated with the received packet, namely (1) the identifier of the ingress I/F on which the packet was received and (2) the associated timestamp indicative of when the packet was received. Processing can return to operation 402 to receive and process the next packet.

### Example

Referring now to FIGS. 2, 3, and 6, consider an example of a packet that is transmitted from endpoint 216a (source) to endpoint 216b (destination). Referring to FIG. 2, the packet will first be sampled at tap point (a) and transmitted to monitoring fabric 104 in packet stream TP1. The service node will see the packet, for the first time, arriving on ingress interface Eth1. Referring to FIG. 6, at time t1, the service node will create a table entry for the packet, comprising the 5-tuple attribute of the flow. The first data pair in the created table entry will comprise an identifier for ingress interface Eth1 and a timestamp corresponding to time t1.

Continuing with the example, the packet will be sampled a second time at tap point (b) and transmitted to monitoring fabric 104 in packet stream TP2. The service node will see the packet at time t2, this time arriving on ingress interface Eth2. Referring to FIG. 6, at time t2, the service node will append a second data pair to the table entry comprising an identifier for ingress interface Eth2 and a timestamp corresponding to time t2.

Continuing with the example, the packet will be sampled a third time (tap point c) and transmitted to monitoring fabric 104 in packet stream TP3. The service node will see the packet at time t3, this time arriving on ingress interface Eth3. The service node will append a third data pair to the table entry comprising an identifier for ingress interface Eth3 and a timestamp corresponding to time t3.

Completing the example, the packet will be sampled a fourth time (tap point d) and transmitted to monitoring fabric 104 in packet stream TP4. At time t4, the service node will see the packet arrive on ingress interface Eth4. The service node will append a fourth data pair to the table entry comprising an identifier for ingress interface Eth4 and a timestamp corresponding to time t4.

### Latency Computations and Anomaly Detection

When a table entry in packet table 500 is deemed to have expired (Y branch of decision point 410), latency computations and packet anomaly detection for the packet instance represented by the table entry can be performed using information contained in the expired entry before the entry is cleared (operation 414). In some embodiments, computing metrics and identifying packet anomalies can be performed based according to the following heuristics:
The data pairs of the expired table entry can be sorted to produce an ordered list of data pairs, ordered according to the tap points from source to destination. For example, the I/F identifier in each data pair identifies the corresponding tap point via the mapping information in I/F map 306b. The IP source and destination addresses in metadata 514 of the expired table entry can be used to identify the corresponding path in path table 306a. The list of tap points in the path identified in path table 306b represents the tap points on the path and their order from source to destination on the path.

The resulting ordered list of data pairs identifies the tap points, in sorted order from source to destination.
Latency computations:
   Latencies between adjacent tap points can be computed from the timestamps in the corresponding adjacent data pairs in the ordered list of data pairs. Referring to FIG. 6 as an example, consider the table entry at time t4. The following latencies can be computed from the data pairs:
      I/F Eth1 (tap point a) to I/F Eth2 (tap point b), latency=t2−t1
      I/F Eth2 (tap point b) to I/F Eth 3 (tap point c), latency=t3−t2
      I/F Eth3 (tap point c) to I/F Eth4 (tap point d), latency=t4−t3
   Statistics (e.g., min, max, mean, P90, P95, P99, etc.) can be computed from the computed latencies.
   It is noted that tap points do not need to be adjacent. For example, because t1 is the earliest timestamp in the sequence it is possible to calculate t2−t1, t3−t1, t4−t1.
Packet anomalies
   dropped packet—A packet can be deemed dropped, if a packet that is expected to show up at a given tap point (i.e., marked with a given interface identifier) but is not received (i.e., its data pair is not present in the table entry when that entry expires). Generally, a packet can be deemed “dropped” if the table entry associated with the packet instance has fewer timestamps recorded in the table entry than tap points, at the time the table entry expires. A packet can be deemed dropped if the latency (e.g., in milliseconds) between adjacent tap points that sampled the packet exceeds a threshold, and so on.
   unexpected packet - An unexpected packet can occur if the packet was sampled from a tap point that is not in the topology database (e.g., topology 306). An unexpected packet can occur due to incorrect topology, for example, resulting from misconfiguration of the network or by the network having changed before the topology is updated.

FIG. 7 depicts a simplified block diagram of an example computer system 700 (e.g., service node 302) according to certain embodiments. As shown in FIG. 7, computer system 700 includes one or more processors 702 that communicate with a number of peripheral devices via bus subsystem 704. These peripheral devices include data subsystem 706 (comprising memory subsystem 708 and file storage subsystem 710), user interface input devices 712, user interface output devices 714, and network interface subsystem 716.

Bus subsystem 704 can provide a mechanism that enables the various components and subsystems of computer system 700 to communicate with each other as intended. Although bus subsystem 704 is shown schematically as a single bus, alternative embodiments of the bus subsystem can utilize multiple buses.

Network interface subsystem 716 can serve as an interface for communicating data between computer system 700 and other devices; e.g., network devices, client computing devices for remote access, etc. Embodiments of network interface subsystem 716 can include, e.g., an Ethernet card, a Wi-Fi and/or cellular adapter, and/or the like. Local access to computer system 700 can be provided via input devices 712 (e.g., keyboard, pointing devices, etc.) and output devices 714 (e.g., a computer monitor, etc.).

Data subsystem 706, comprising memory subsystem 708 and file/disk storage subsystem 710, represents non-transitory computer-readable storage media that can store program code and/or data, which when executed by processor 702, can cause processor 702 to perform operations in accordance with embodiments of the present disclosure.

Memory subsystem 708 includes memory circuits such as main random access memory (RAM) 718 for storage of instructions and data during program execution and read-only memory (ROM) 720 in which fixed instructions are stored. File storage subsystem 710 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and many other configurations having more or fewer components than system 700 are possible.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method comprising:
receiving a plurality of packet streams on a plurality of corresponding ingress interfaces of the monitoring fabric, each packet stream comprising packets tapped from a corresponding tap point among a plurality tap points in a production network, wherein each ingress interface corresponds to a tap point in the production network;
associating a timestamp with each packet in the received packet streams that represents when the packet arrived at its corresponding ingress interface;
generating packet identifiers for packets in the received packet streams, wherein instances of a first packet that are tapped from multiple tap points in the production network occur in multiple separate packet streams corresponding to the multiple tap points and have a same packet identifier;
associating packet identifiers of the packets with their respective timestamps and ingress interfaces; and
computing a latency of a packet between first and second tap points in the production network by computing a difference between (1) a first timestamp associated with a first instance of the first packet in the packet stream received on the ingress interface associated with the first tap point and (2) a second timestamp associated with a second instance of the first packet in the packet stream received on the ingress interface associated with the second tap point.

2. The method of claim 1, wherein the timestamp correlates with when the packet was tapped from its tap point in the production network.

3. The method of claim 1, wherein generating packet identifiers for packets in the received packet streams comprises computing hash values on packet contents of the packets.

4. The method of claim 3, wherein the packet contents include payloads of the packets.

5. The method of claim 3, wherein computing hash values includes masking out one or more data fields of the packets.

6. The method of claim 1, further comprising detecting dropped packets based on latencies of packets that exceed a threshold.

7. The method of claim 1, further comprising determining a second packet has been dropped when a first instance of the second packet occurs in a packet stream received on an ingress interface associated with a first tap point in the production network and a second instance of the second packet is absent from a packet stream received on an ingress interface associated with a second tap point in the production network.

8. The method of claim 1, wherein the plurality of tap points are tap points along paths in the production network between source nodes and destination nodes.

9. An apparatus comprising:
one or more computer processors; and
a computer-readable storage device having computer executable instructions that control the one or more computer processors to perform routing of circuit paths in a circuit design, including computer executable instructions that control the one or more computer processors to:
receive a plurality of packet streams, each packet stream comprising packets tapped from a corresponding tap point among a plurality tap points in a production network, each packet in each packet stream associated with a timestamp that correlates with a time when the packet was tapped from its corresponding tap point in the production network;
identify an instance of a packet that occurs among the plurality of packet streams; and
compute latencies between adjacent tap points in the production network from which the identified instance of the packet was tapped by computing differences between timestamps associated with occurrences of the identified instance of the packet in packet streams that correspond to the adjacent tap points.

10. The apparatus of claim 9, wherein the computer-readable storage device further includes instructions that control the one or more computer processors to detect a packet drop of the identified instance of the packet, wherein the packet drop is deemed to have occurred when the computed time difference exceeds a threshold.

11. The apparatus of claim 9, wherein the computer-readable storage device further includes instructions that control the one or more computer processors to detect a packet drop of the identified instance of the packet, wherein the packet drop is deemed to have occurred when the identified instance of the packet occurs in a first packet stream and is absent in an adjacent packet stream.

12. The apparatus of claim 9, wherein the computer-readable storage device further includes instructions that control the one or more computer processors to receive the plurality of packet streams from a plurality of corresponding ingress interfaces on edge devices of a monitoring fabric, wherein the edge devices associate the packets with timestamps that represent a time of arrival at the ingress interfaces.

13. The apparatus of claim 9, wherein the computer-readable storage device further includes instructions that control the one or more computer processors to:
compute, for each packet in each packet stream, a hash value using packet contents of the packet to identify the packet; and
create an association between the computed hash value of the packet, the ingress point on which the packet arrived, and the timestamp associated with the packet, wherein occurrences of the identified instance of the packet among the plurality of packet streams computes to the same hash value.

14. The apparatus of claim 9, wherein the plurality of tap points are tap points along a path from a source node in the production network to a destination node in the production network.

15. A non-transitory computer-readable storage device in a network device, the non-transitory computer-readable storage device having stored thereon computer executable instructions, which when executed, cause the network device to:
receive a plurality of packet streams, each packet stream comprising packets tapped from a corresponding tap point among a plurality tap points in a production network, each packet in each packet stream associated with a timestamp that correlates with a time when the packet was tapped from its corresponding tap point in the production network;
identify an instance of a packet that occurs among the plurality of packet streams; and
compute latency between adjacent tap points in the production network from which the identified instance of the packet was tapped by computing a difference between timestamps associated with occurrences of the identified instance of the packet in packet streams that correspond to the adjacent tap points.

16. The non-transitory computer-readable storage device of claim 15, wherein the computer executable instructions, which when executed, further cause the network device to detect a packet drop of the identified instance of the packet, wherein the packet drop is deemed to have occurred when the computed time difference exceeds a threshold.

17. The non-transitory computer-readable storage device of claim 15, wherein the computer executable instructions, which when executed, further cause the network device to detect a packet drop of the identified instance of the packet, wherein the packet drop is deemed to have occurred when the identified instance of the packet occurs in a first packet stream and does not occur in an adjacent packet stream.

18. The non-transitory computer-readable storage device of claim 15, wherein the computer executable instructions, which when executed, further cause the network device to receive the plurality of packet streams from a plurality of corresponding ingress interfaces on edge devices of a monitoring fabric, wherein the edge devices associate the packets with timestamps that represent a time of arrival at the ingress interfaces.

19. The non-transitory computer-readable storage device of claim 15, wherein the computer executable instructions, which when executed, further cause the network device to:
compute, for each packet in each packet stream, a hash value using packet contents of the packet to identify the packet; and
create an association between the computed hash value of the packet, the ingress point on which the packet arrived, and the timestamp associated with the packet, wherein occurrences of the identified instance of the packet among the plurality of packet streams computes to the same hash value.

20. The non-transitory computer-readable storage device of claim 15, wherein the plurality of tap points are tap points along a path from a source node in the production network to a destination node in the production network.
